(19) United States
(12) Patent Application Publication
(10) Pub. No.: US 2002/0105624 A1
(43) Pub. Date: Aug. 8, 2002

(54) Voice-activated video projector

(76) Inventor: Kenya Quori, Stafford, TX (US)

Correspondence Address: John D. Gugliotta, P.E., Esq., 202 Delaware Building, 137 South Main Street, Akron, OH, 44308, US

(21) Appl. No.: 09/777,438

(22) Filed: Feb. 6, 2001

(51) Int. Cl. G03B 21/00

(52) U.S. Cl. 353/122; 359/142

(57) ABSTRACT

A voice-activated video display mechanism that projects or displays information on a screen during a presentation as controlled by a user's voice is disclosed. The preprogramed slides or pictures change in response to certain spoken words by the presenter. Such functionality permits seamless display of information that corresponds directly to the speaker's spoken word thus allowing for a presentation that is easier to comprehend and understand. Also, the projector has capabilities for the playback of DVD media, either as part of a presentation or as a separate standalone DVD viewer. A built in printer also allows for the production of hard copies of the displayed information.

### RELATED APPLICATIONS

The present invention was first described in Disclosure Document Number 467,200 filed on Jan. 3, 2000. There are no previously filed, nor currently any co-pending applications, anywhere in the world.

### BACKGROUND OF THE INVENTION

1. Field of the Invention

The present invention relates generally to optical image projectors and, more particularly, to a voice-activated video display mechanism.

2. Description of the Related Art

The art of making a presentation is something that is practiced by many but mastered by only a few. The requirement of keeping the audience's attention and making the presented materials easy to understand is a must. Various aids such as overhead transparencies, presentation software, display screens, whiteboards, chalkboards and the like help in the regard, but all suffer from the drawback that the user must manually control the visual aid during the presentation. Such control disrupts the flow of the presentation as well as reduces the time available for the presenter to speak.

A search of the prior art did not disclose any patents that read directly on the claims of the instant invention; however, the following references were considered related.

The following patents disclose a remote control slide projector control system connected to telephone lines or RF/IR devices:

U.S. Pat. No. 6,035,350 issued in the name of Swamy et al.

U.S. Pat. No. 4,747,121 issued in the name of Nash et al.

The following patents describe a voice-activated video camera for recording:

U.S. Pat. No. 4,809,079 issued in the name of Blazek et al.

U.S. Pat. No. 4,791,477 issued in the name of Blazek et al.

U.S. Pat. No. 4,764,817 issued in the name of Blazek et al.

U.S. Pat. No. 5,781,408 issued in the name of Crane, Jr. et al. discloses a computer system with a voice-activated sensor.

U.S. Pat. No. 5,744,788 issued in the name of Metlitsky et al. describes a voice-activated optical scanning system.

U.S. Pat. No. 5,541,680 issued in the name of Fromm discloses a slide projector assembly with soundtrack means.

U.S. Pat. No. 4,122,613 issued in the name of Karalus et al. describes an operator-responsive audiovisual teaching apparatus.

Consequently, there exists a need for a means by which visual presentation aids can have the requirement of manual control during a presentation removed during a presentation, thus improving the overall quality of the presentation.

### SUMMARY OF THE INVENTION

It is therefore an object of the present invention to provide an improved video projector system.

It is a feature of the present invention to provide an improved video projector system that can be voice-activated in order to advance or retreat the displayed video image based upon the users' audible command.

It is yet another feature of the present invention to provide an improved video projector system that can display projected video images from either conventional DVD or CD inputs.

Briefly described according to one embodiment of the present invention, the voice-activated video display mechanism is provided that projects or displays information on a screen during a presentation as controlled by a user's voice. Upon initial observation, the invention looks remarkably like a common computerized projection system capable of displaying written words, graphs, diagrams, charts, pictures and the like. But after closer observation, it can be seen the various projected elements change in response to the user's voice. The preprogramed electronic slides or pictures change in response to certain spoken words by the presenter. Such functionality permits seamless display of information that corresponds directly to the speaker's spoken word thus allowing for a presentation that is easier to comprehend and understand. The invention also has capabilities for the playback of DVD or CD media, either as part of a presentation or as a separate standalone DVD viewer. A built in printer also allows for the production of hard copies of the displayed information.

The use of the present invention allows speakers and presenters the ability to produce presentations with a seamless method of integrating both visual presentation aids and the spoken word in a manner which is not only easy to understand but less confusing and distracting as well.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a perspective drawing of the voice-activated video projector shown in a utilized state according to a preferred embodiment of the present invention.

FIG. 2 is a detailed elevation of the control panel as used with the present invention;

FIG. 3 is an electrical block diagram depicting the major components as used with the present invention; and

FIG. 4 is a functional logic diagram depicting the internal logic used in the present invention.

### DESCRIPTION OF THE PREFERRED EMBODIMENTS

The best mode for carrying out the invention is presented in terms of its preferred embodiment, herein depicted within the Figures.

1. Detailed Description of the Figures

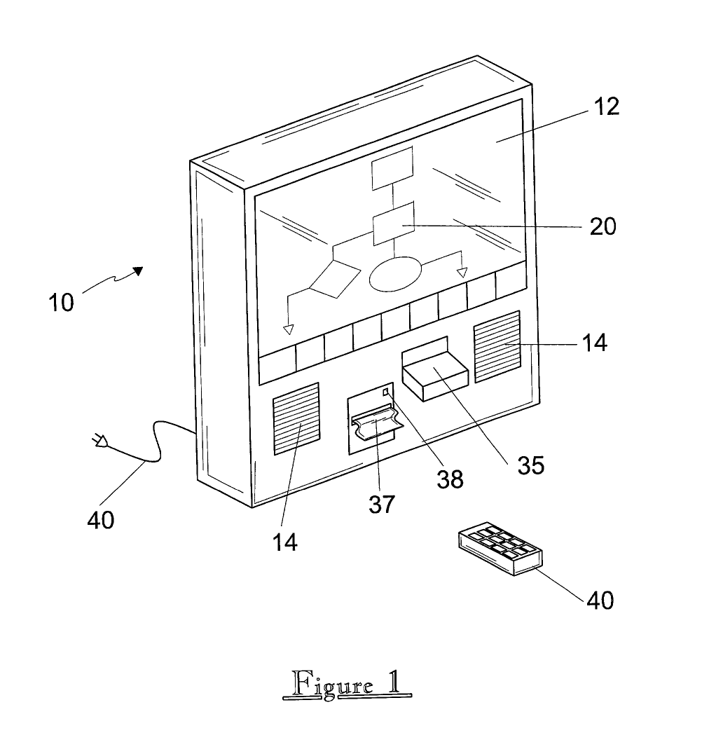

Referring now to FIG. 1, a perspective drawing of the voice-activated video projector 10 shown in a utilized state is depicted, according to the present invention. The voice-activated video projector 10 is envisioned as a freestanding assembly housing a video image screen 12 as well as audio output speaker assemblies 14. The voice-activated video projector 10 produces a projected visual image 20 upon the display screen 12. Located upon the front of the voice-activated video projector 10 is a control panel 35 for allowing manual input in a manner which will be described in greater detail herein below. Further, a touch screen control mechanism is also provided for interaction with the display screen 12. Also within the housing of the voice-activated video projector 10 is a printer 37, envisioned to be of the thermal variety, but inkjet-based or laser-based printers will serve equally well. The printer 37 is used to provide hard copy paper prints of whatever is currently being shown on the projected visual image 20 when a print button 38 is pressed. Finally, the voice-activated video projector 10 is powered by a power cord 40, allowing the invention to be powered by 120 volts AC or any other readily available electrical power source.

A remote input device 40 is provided for wireless interaction with the projected visual image 20 of the voice-activated video projector 10. This accessory provides a portable input emulating the touch screen input for remote viewers.

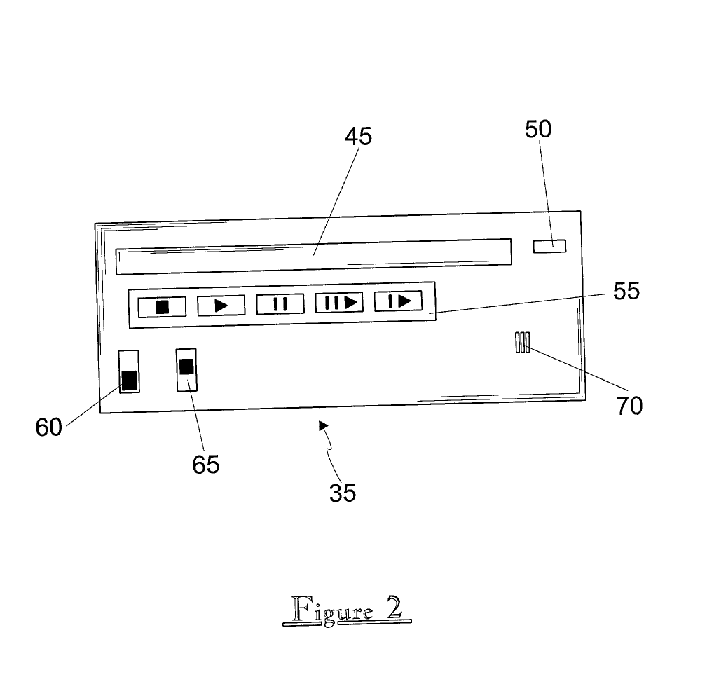

Referring now to FIG. 2, a detailed elevation of the control panel 35 as used with the present invention is shown. The control panel 35 provides an insertion slot 45 for either a DVD or CD. It is envisioned that CD's would be used for preprogrammed slide presentations or film conversions of conventional filmstock or videotape, such as those produced by Microsoft's Power Point® software program, or could also be used to project photographic images taken by a digital camera and stored on the CD in a manner similar to a film-based slide presentation. It is envisioned that DVD's would be used to show feature-rich, long-length visual programs or could also be used to show conventional movie-based DVD's in a wide-screen format. Located to the immediate right of the insertion slot 45 is an eject button 50, thus allowing the removal of either the CD or DVD. Placed below the insertion slot 45 is a control switch array 55 providing conventional controls for the CD or DVD player such as STOP, PLAY, PAUSE, SEARCH, and SCAN. Located on the bottom section of the control panel 35 is a power switch 60 and a mode control switch 65, used to control the operating mode of the voice-activated video projector 10. Finally, located at the lower right hand control of the control panel 35 is an audio transducer 70 such as a microphone. The audio transducer 70 is used to receive audible commands spoken by the user to control the advancement or retracement of the projected visual image 20 (as shown in FIG. 1) produced by solid state electronics in conjunction with the internal CD/DVD player. By way of example, and not by limitation, the use of an open architecture programming language such as Sun Microsystems® TLX or Jini(TM) can be used to program the slides remotely for transfer to a CD or DVD medium. This allows for use of preprogrammed presentations, or saving and repeating of a given presentation. An internal processing unit can thereby allow for retrieval and display of the various images, as well as for programming of a specific slide show sequence or saving and repeating of an existing or previous slide show sequence by use of audio commands. The operation of the audio transducer 70 will be described in greater detail herein below.

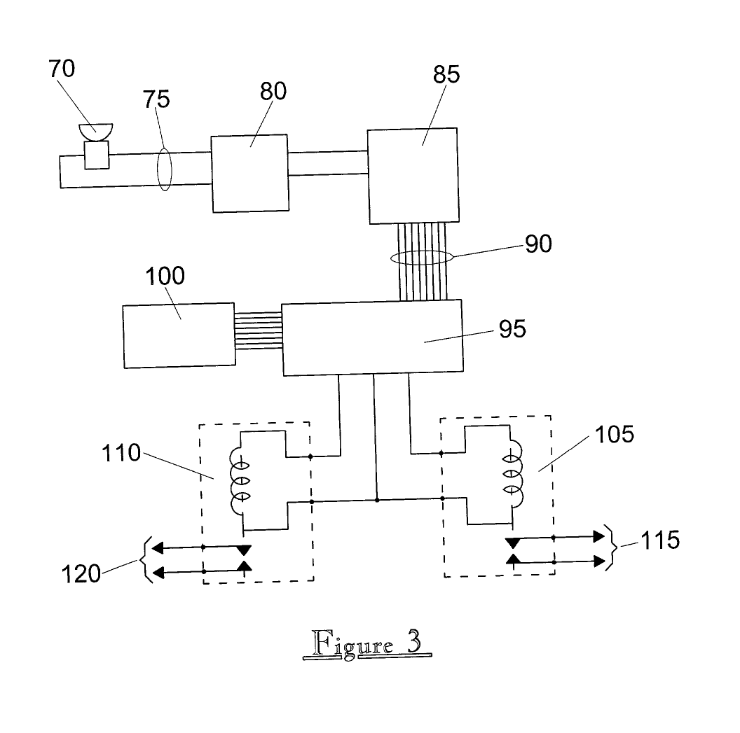

Referring next to FIG. 3, an electrical block diagram depicting the major components of the voice-activated video projector 10 is shown. The audio transducer 70 produces an analog signal 75 in direct response and proportion to the pressure waves or sound waves produced by the voice of the user. The analog signal 75 is amplified by an amplifier 80. The output of the amplifier 80 is routed to an analog to digital converter 85, of conventional design, where the analog signal is converted to a digital signal 90. The digital signal 90 would be a real-time signal and produced on a continuous basis. The digital signal 90 is fed into a digital comparator 95. A random access memory chip 100 is used to store multiple digital waveforms of the words “FORWARD” and “BACK” in various, slightly different dialects and emphasis levels. Additional commands are envisioned as programmable, such as “SAVE”, “REPEAT”, and “PRINT” commands. A audibly prompted troubleshooting menu allowing for a selection of commands, or to verify operations or skip operations can be accessed through a “MENU” command or similar command, allowing complete hands-free operation of the projector 10. It is envisioned that the waveforms stored would match the spoken word of the vast majority of the population. The digital comparator 95 would take the digital signal 90 as provided by the digital signal 90 and compare it to the waveform provided in the random access memory chip 100 and provided a match in two instances. The first instance would be a match of the word “FORWARD” which would activate a first relay 105. The second instance would be a match of the word “BACK” which would activate a second relay 110. Both the first relay 105 and the second relay 1 10 are shown as of the standard electromagnetic mechanical type to provide isolation, but other types of isolation such as transistor-based or optical-based isolation could also be used with equal effectiveness. The first relay 105 and the second relay 1 10 would produce an advancement signal 115 and a retracement signal 120 respectively, of a dry-contact nature to advance or retract the projected visual image 20.

The intent of the present invention is to provide an independently operated device free of manual manipulation during presentations, and operating entirely from audible input commands.

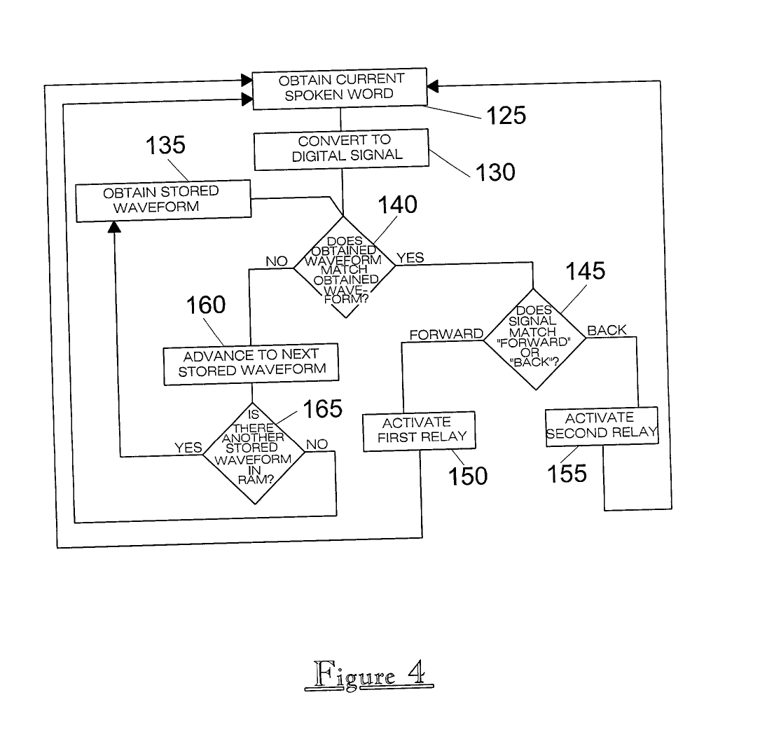

Referring finally to FIG. 4, a functional logic diagram depicting the internal logic used in the present invention is shown. The logic process begins at a first functional block 125 where the current spoken word is obtained through the audio transducer 70, and the amplifier 80 (as shown in FIG. 3). The spoken word is converted to a digital signal at a second functional block 130. Next, the current stored word is obtained at a first operational block 135. The spoken word and the obtained word are compared at a second operational block 140 corresponding to the digital comparator 95 (as shown in FIG. 3). If there is a match, as indicated by a positive response at the second operational block 140, the logic path proceeds to a third functional block 145 where signal is verified for a match for the word “FORWARD” or “BACK.” In the case of a “FORWARD” match, the first relay 105 (as shown in FIG. 3) is activated at a fourth functional block 150 and the process flow returns to the first functional block 125 where it begins again. In the case of a “BACK” match, the second relay 110 (as shown in FIG. 3) is activated at a fifth functional block 155 and the process flow returns to the first functional block 125 where it begins again. If there is no match at the second operational block 140 as indicated by a negative response, the process advances to the next stored waveform at a third operational block 160. At this point the logic checks to see if there is another stored waveform in the random access memory chip 100 (as shown in FIG. 3) at a sixth functional block 165. If there is as indicated by a positive response to the sixth functional block 165, the process returns to the first operational block 135, and continues as described above. If there is a negative response to the sixth functional block 165, meaning that the entire library has been checked and no match achieved, the logic will return to the first functional block 125.

2. Operation of the Preferred Embodiment

The present invention is designed with ease of operation features in mind that allow it to be setup and utilized by a common individual with little or no training, and operated in a transparent and intuitive manner with respect to other electronic devices. To use the present invention, the user simply sets or supports the voice-activated video projector 10 on a supporting means 15 and connects it to a source of power using the power cord 40. A suitable presentation, using either film-based slides, a CD or a DVD is loaded into the invention using the insertion slot 45. After activation, the user or presenter simply needs to say the word “FORWARD” when advancement to the next frame is desired. If the presenter wishes to go back to a previous slide, he or she simply needs to say the word “BACK” to retrace. The invention is suitable for use on in individual basis, but is envisioned to be used during group presentations primarily. The lack of having to use a remote control, or return to the projection unit during a presentation to advance or retrace slides is an advantage when trying to keep the audience's interest and maintain a flow of thought. If a certain slide is desired for a print out, one simply needs to access the “PRINT” command audibly for a hard copy from the internal printer 37. The DVD playback functions of the voice-activated video projector 10 also allow it to function as a wide-screen projection unit capable of playing DVD's which contain feature-length cinematic films as well.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents. Therefore, the scope of the invention is to be limited only by the following claims.

What is claimed is:

1. An audible actuated video projector comprising:
a video projector for displaying a video image in a projection fashion on a flat, remote surface;
means for receiving an audio command from a user and for generating therefrom a control signal; and
control circuitry for controlling image advancement of said video projector in response to said control signal.

2. The audible actuated video projector of claim 1, wherein said means for receiving an audio command from a user and for generating therefrom a control signal comprises an audio input circuit.

3. The audible actuated video projector of claim 2, wherein said audio input circuit includes a transducer for converting an audio command uttered by a user into an electrical audio signal.

4. The audible actuated video projector of claim 3, wherein the control circuit processes the electrical audio signal, and generates a control signal for initiating operation of the video projector.

5. The audible actuated video projector of claim 1, further comprising a manual control means for controlling image advancement of said video projector in response to said control signal.

6. The audible actuated video projector of claim 1, wherein said video images being displayed are projected from electronic image files obtained from a computer readable media.

7. The audible actuated video projector of claim 6, wherein said video images being displayed are projected from a digital medium.

8. The audible actuated video projector of claim 7, wherein said digital medium comprises a digital video disc (DVD).

9. The audible actuated video projector of claim 1, further comprising means for producing hard copy output.

10. The audible actuated video projector of claim 9, wherein said means for producing hard copy output is controlled by said means for receiving an audio command from a user and for generating therefrom a control signal.

11. The audible actuated video projector of claim 1, wherein said control circuitry further comprises an internal processing unit capable of retrieval and display of stored electronic images.

12. The audible actuated video projector of claim 1, wherein said control circuitry further comprises the capability for programming of a specific slide show sequence.

13. The audible actuated video projector of claim 1, wherein said control circuitry further comprises the capability for saving and repeating of an existing or previous slide show sequence by use of audio commands.
